(19) United States
(12) Patent Application Publication
(10) Pub. No.: US 2009/0305208 A1
(43) Pub. Date: Dec. 10, 2009

(54) System and Method for Improving Fine Motor Skills

(76) Inventors: Duncan Howard Stewart, Colorado Springs, CO (US); Matthew Bruce Hellier, Erid, OK (US); Kevin P. Maher, Colorado Springs, CO (US); Nicholis Bufmack, Colorado Springs, CO (US); Bret Nelson, Colorado Springs, CO (US); Sebastian Kwon, Clearfield, UT (US)

Correspondence Address: LAW OFFICE OF DALE B. HALLING, 3595 FOUNTAIN BOULEVARD SUITE A2, COLORADO SPRINGS, CO, 80910, US

(21) Appl. No.: 12/483,820

(22) Filed: Jun. 12, 2009

Related U.S. Application Data
(63) Continuation-in-part of application No. 11/471,442, filed on Jun. 20, 2006.
(60) Provisional application No. 61/132,011, filed on Jun. 13, 2008.
(60) Provisional application No. 61/161,492, filed on Mar. 19, 2009.

(51) Int. Cl. G09B 19/00

(52) U.S. Cl. 434/258

(57) ABSTRACT

A system for improving fine motor skills includes a stylus. An electronic tablet detects a position of the stylus (or finger) when the stylus is near a surface of the electronic tablet. A process defines and draws tolerance band on the electronic tablet. The tolerance band may be defined by a visual marker. The process may define a starting position and an end position within the tolerance band. The system includes an auto challenge module that determines if the user is ready to advance to a more difficult lesson. The system also includes an auditory association module that plays a sound associated with the shape. The system includes a foreign language module that teaches the user how to correctly write a foreign language. Finally, there is an analysis module that provides both instantaneous feedback and show the progress of the user over time.

### RELATED APPLICATIONS

The present invention is a continuation-in-part of patent application, Ser. No. 11/471,442, filed on Jun. 20, 2006 entitled “Training System and Method”, and claims priority on provisional patent application, Ser. No. 61/132,011, filed on Jun. 13, 2008, entitled “Interactive Handwriting Training System and Method” and provisional patent application, Ser. No. 61/161,492 filed on Mar. 19, 2009, entitled “Interactive Handwriting Training System and Method” and all of which are hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Many children suffer from visual attention disorder (VAD). These children have wandering eyes and difficulty focusing on any task requiring eye/hand coordination. This is especially true when these children try to write and results in these children having an extremely difficult time learning to write. The current method of teaching these children how to write is a paper based system. The children are asked to draw a line between two related objects such as a bird and its nest. Therapists have found this paper system fails to grab the child's attention for more than a few minutes. Using this paper method is costly to the taxpayer, insurance companies, and to the parents due to the extended period of time it takes the student to learn to write.

Thus, there exists a need for a training system that is more effective at capturing the student's attention and decreases the time it takes them to learn to write.

### BRIEF SUMMARY OF INVENTION

A training system that overcomes these and other problems has a stylus. An electronic tablet detects a position of the stylus (or finger) when the stylus is near a surface of the electronic tablet. A process defines and draws a tolerance band on the electronic tablet. The process may define a starting position and an end position within the tolerance band. An audio cue may play while the stylus progresses from the starting position to the end position. A failure to progress may include going outside the tolerance band. A lesson generating program generates the lessons. A tracking and measuring program stores measurements based on the stylus movement. Using this system the child is provided positive audio feedback and visual feedback of the progress they are making. This feedback captures the child's attention and increases the number of exercises they are willing to perform during a lesson with a therapist. The system also includes an auto challenge module that automatically increases the lesson difficulty as the child progress. The system tracks a child's progress and displays graphics of their progress. In one embodiment, the system announces the sound of the shape the user is attempting to draw. The system may also request that the user pronounce the name of the shape they are drawing and determine a correctness of their pronunciation.

Standard writing lessons fail to capture the attention of a child with VAD (visual attention disorder) or other attention deficient disorders. As a result, standard writing lessons that do not provide immediate positive feedback will not succeed in teaching these children fine motor skills.

### BRIEF DESCRIPTION OF THE SEVERAL VIEWS OF THE DRAWINGS

FIG. 1 is a perspective view of the training system in accordance with one embodiment of the invention;

FIG. 2 is an example of a writing template in accordance with one embodiment of the invention;

FIG. 3 is block diagram of the training system in accordance with one embodiment of the invention;

FIG. 4 is a flow chart of the steps used in a method of operating a training system in accordance with one embodiment of the invention;

FIG. 5 is a block diagram of a system for improving fine motor skills in accordance with one embodiment of the invention;

FIG. 6 is a flow chart of the steps used in a method of improving fine motor skills in accordance with one embodiment of the invention;

FIG. 7 is a flow chart of the steps used in a method of improving fine motor skills in accordance with one embodiment of the invention;

FIG. 8A is an example of an input screen of a system for improving fine motor skills in accordance with one embodiment of the invention;

FIG. 8B is an example of an output screen of a system for improving fine motor skills in accordance with one embodiment of the invention;

FIG. 9A is an example of an input screen of a system for improving fine motor skills in accordance with one embodiment of the invention;

FIG. 9B is an example of an output screen of a system for improving fine motor skills in accordance with one embodiment of the invention;

FIGS. 10A, 10B and 10C are examples of an input screens of a system for improving fine motor skills in accordance with one embodiment of the invention;

FIG. 11 is a method of teaching a user to write a foreign language in accordance with one embodiment of the invention.

### DETAILED DESCRIPTION OF THE INVENTION

A system for improving fine motor skills includes a stylus. An electronic tablet detects a position of the stylus (or finger) when the stylus is near a surface of the electronic tablet. A process defines and draws tolerance band on the electronic tablet. The tolerance band may be defined by a visual marker. The process may define a starting position and an end position within the tolerance band. An audio cue may play while the stylus progresses from the starting position to the end position. A failure to progress may include going outside the tolerance band. A lesson generating program generates the lessons. A tracking and measuring program stores measurements based on the stylus movement. Using this system the child is provided positive audio feedback and visual feedback of the progress they are making. This feedback captures the child's attention and increases the number of exercises they are willing to perform during a lesson with a therapist. The system also includes an auto challenge module that automatically increases the lesson difficulty as the child progress. The system tracks a child's progress and displays graphics of their progress. In one embodiment, the system announces the sound of the shape the user is attempting to draw. The system may also request that the user pronounce the name of the shape they are drawing and determine a correctness of their pronunciation.

Standard writing lessons fail to capture the attention of a child with VAD (visual attention disorder) or other attention deficient disorders. As a result, standard writing lessons that do not provide immediate positive feedback will not succeed in teaching these children fine motor skills.

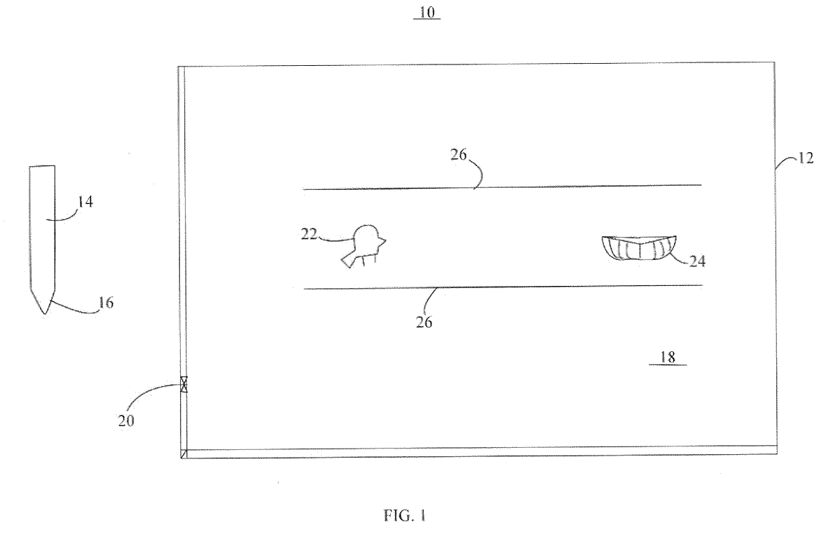

FIG. 1 is a perspective view of the training system 10 in accordance with one embodiment of the invention. The training system 10 includes an electronic tablet 12, which is a computer with an electronic writing surface. The electronic tablet 12 includes a stylus 14 and the electronic tablet senses when the tip 16 of the stylus 14 is on (or very near) the surface 18 the electronic tablet 12. The electronic tablet 12 has a speaker 20. A lesson is shown on the tablet 12. In this lesson a bird 22 defines a starting position and a nest 24 defines the ending position. A tolerance band 26 is defined by a pair of lines. In another embodiment, the tolerance band is defined by a color or shading. The student is asked to draw a line between the bird 22 and its nest 24. In one embodiment when the student places the stylus 14 on the bird 22 music or some other audio cue starts to play. In another embodiment when the student places the stylus 14 on the bird 22 the bird starts to dance or some other animation is provided and the bird follows the stylus. As long as the student makes progress advancing the stylus from the starting position 22 to the end position 24 the music (or animation) continues to play. If the student stops making progress, the music stops or a different (failure mode) music plays and the student has to place the stylus on the starting position for the music to start again. Other failure modes include going outside the tolerance band 26, leaving the stylus in the same position for too long, moving the stylus back towards the staring position, picking the stylus up from the surface 18 of the tablet 12, and others that a therapist may want to define. Note, that in one embodiment if the stylus fails to make progress the bird returns to the starting position 22. If the student successfully draws a line from the bird to the nest, success music may play or another animation may appear.

The stylus does not contain any electronics as a result the child or user can use their finger instead of a stylus. This provides flexibility in case the user has a difficult time holding a pen, pencil, or stylus. The digitizing screen 12 may be an electronic whiteboard or a touch screen. In all cases the digitizing screen 12 acts both as a display and an input device.

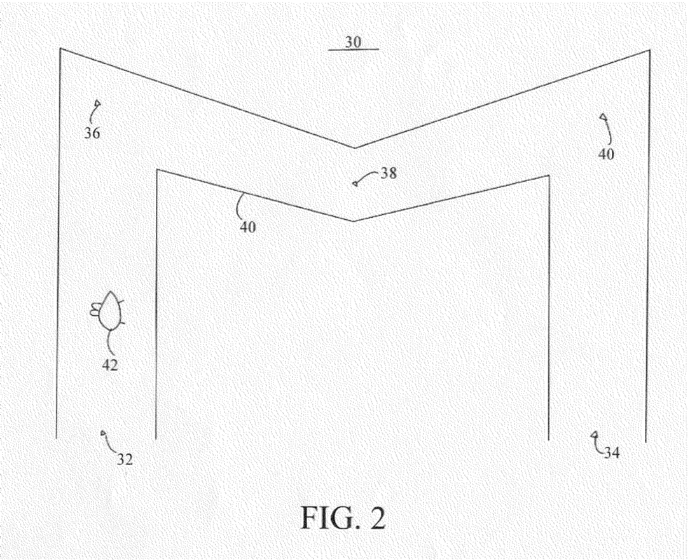

FIG. 2 is an example of a writing template 30 in accordance with one embodiment of the invention. This template 30 illustrates a more complex writing task. The template has a starting point 32 and an end point 34. However, because this is not a straight line or continuous circle the template has waypoints 36, 38, 40. Each waypoint can be considered a starting and an ending point. A pair of tolerance bands 40.are defined around the waypoints 32, 34, 36, 38, 40. A rabbit 42 or chase car feature is used to guide the child as he moves the stylus between the waypoints. The rabbit 42 stays in front of the stylus and the child is told to try to catch the rabbit. In one embodiment, the stylus is allowed to catch up to the rabbit at each waypoint.

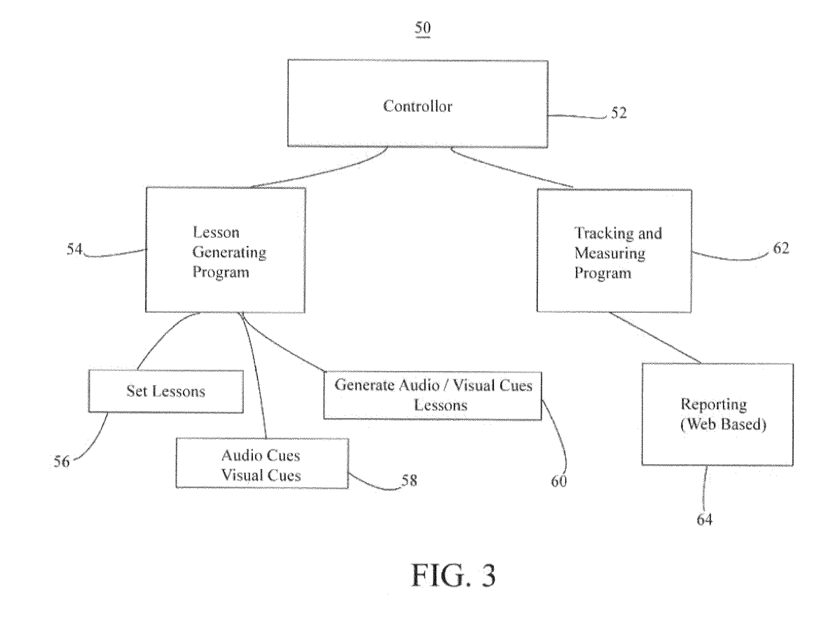

FIG. 3 is block diagram of the training system 50 in accordance with one embodiment of the invention. This block diagram 50 provides a high level understanding of the software used with the training system. A controller 52 provides the initial user interface and allows the therapist to setup the electronic tablet to perform the desired function. From the initial user interface the therapist can select a lesson generating program 54 that creates the lessons for the students. The lesson generating program 54 includes a group of set lessons 56. The therapist can select any of these lessons for the student. In addition, the lesson generating program includes a number of audio and visual cues 58. These audio and visual cues 58, which can include animation, may be part of the set lessons 56. In addition, the therapist can generate lessons 60. The generate lessons feature 60 allows the therapist to create shapes, alter tolerance bands, select predefined audio and visual cues or generate new audio or visual cues. The software also includes a tracking and measuring program 62. The therapist can define a profile for each student and then track their performance. The tracking and measuring program can track types of failures, success rates, how long it takes for the student to complete a task, statistics for these measurements and allows the therapist to add comments or subjective information including attentiveness. These measurements can be shared with parents and teachers or other therapist using the reporting feature 64. The reporting feature may be a web based transfer or storage of the measurements.

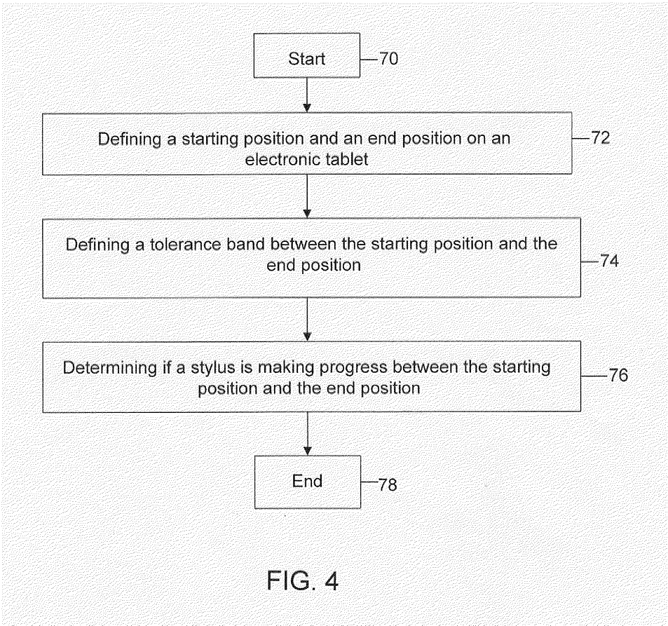

FIG. 4 is a flow chart of the steps used in a method of operating a training system in accordance with one embodiment of the invention. The process starts, step 70, by defining a starting position and an end position on an electronic tablet at step 72. A tolerance band between the starting position and the end position is defined at step 74. At step 76 it is determined if a stylus is making progress between the starting position and the end position which ends the process at step 78. When the stylus is making progress between the starting position and the end position an audio cue is played and when progress is not being made the audio cue stops playing.

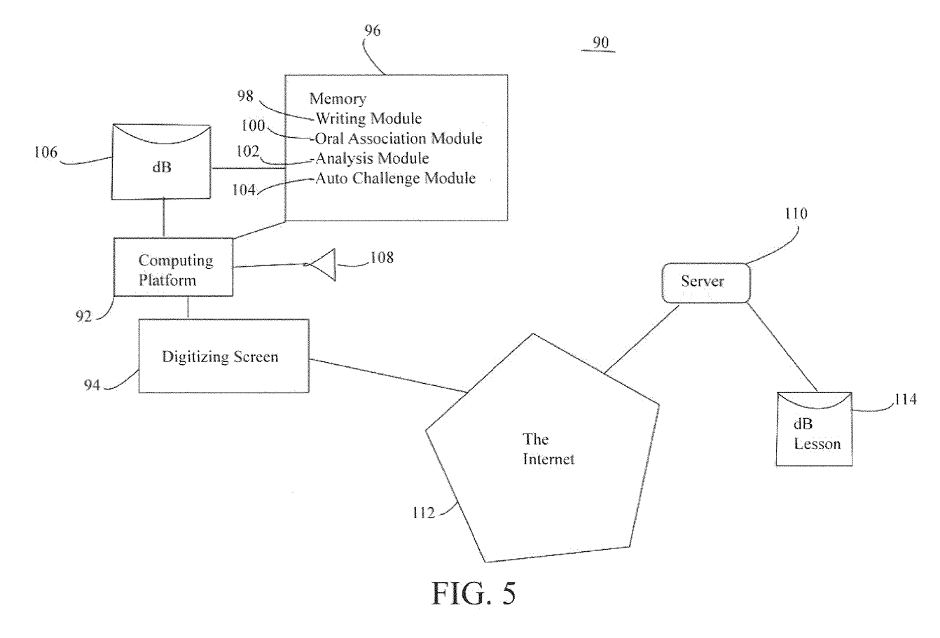

FIG. 5 is a block diagram of a system 90 for improving fine motor skills in accordance with one embodiment of the invention. The system 90 has computer platform 92. The computing platform 92 is in communication with a digitizing screen 94. Memory 96 is associated with the computing platform 92. A writing module 98 includes a number of lessons that contain visual tolerance bands. An auditory association module 100 plays the sound of a shape being displayed in a lesson or exercise. An analysis module 102 tracks a number of parameter for each user. The parameters include:
handwriting accuracy (deviation from center line)
number of failed attempts
time to complete a handwriting task
handwriting problems that may be associated with a particular color
handwriting problems that may be associated with different size fonts
handwriting problems that may be associated with different handwriting strokes, angles, shapes or shape size
handwriting problems that may be associated with different letter, number or shape sequences
handwriting problems that may be associated with different letter, number or shape combinations
handwriting abilities that may be affected by different types of adaptive stylus' or stylus grips
handwriting abilities that may be affected by different body position of the student or patient
handwriting abilities that may be affected by different positions, angles or location of the writing surface
handwriting abilities that may be affected by different types of audible motivations or distractions
other abilities or problems made obvious through the use of the interactive handwriting training system.
   Precise handwriting data including type of shape, height of shape, width of shape, color of shape, date and time of each shape handwriting test, accuracy of handwriting ability (computerized measurement of deviation from centerline), length of time testing a particular shape, length of time testing all shapes, notes taken during each handwriting test, snapshots of each handwriting test, comparison of multiple snapshots at one time, and skill level calculated as [( height of shape+width of shape)×5]×Accuracy Value×0.01 is captured and charted or displayed on the chart page in the software program.

The chart page includes new graphics and precise representations of student's and patient's handwriting abilities and provides new opportunities to analyze, optimize and record handwriting lessons. The charts provides the teacher, parent or therapist with computer generated analytical data that guides them in determining the next steps to take in optimizing the handwriting lesson for patients and students.

The analysis module is designed to interact with the user, stylus and tablet pc, to capture precise data of the handwriting skills of the user and display it instantly on the computer screen in a form that is easily interpreted by the user such as an active color coded bar chart, needle gauge or numerical value. The accuracy information will be displayed on the computer screen in close proximity to the handwriting task and in such a way that the user will be able to focus their attention on the handwriting task at hand and at the same time view their accuracy score through their peripheral vision.

The instantaneous handwriting accuracy information display will benefit the user because it allows the user to monitor their progress with a high degree of accuracy concurrent to their handwriting task. It removes the propensity for human error in judgment or subjective interpretations of handwriting skills typically associated with manual scoring methods. It indicates handwriting skills where the user has a high degree of accuracy and also where the user has difficulty and should continue more training. This motivates the user because it provides an easy, efficient, and effective way to challenge their previously generated scores, similar to the way challenge is found attractive in many popular video games. This is very beneficial for patients recovering from a stroke. Rehabilitating from stroke and other brain injuries may take a very long time and sometimes does not happen at all. Recovering the ability for written language may be extremely difficult, time consuming and frustrating. Patients typically become frustrated with relearning their handwriting skills because they cannot discern from one day to the next or one month to the next if they are improving. The instantaneous handwriting accuracy and average accuracy information display of this invention will benefit patients by motivating them with an accurate method for scoring and tracking their progress.

An auto challenge module 104 uses these parameters to determine if the user is ready for a higher (lower) level of difficulty for a particularly shape. Note that the difficulty can be adjusted by changing the tolerance bands or by changing the size of the shape.

A database 106 of the parameters is created. A speaker 108 is associated with the computing platform 92. The computing platform 92 may connect to a lesson server 110 through the internet 112. The lesson server 110 may have a database 114 of additional lessons that can be downloaded to the computing platform 92.

In one embodiment, the auditory association module includes a voice recognition module. The lesson prompts the uses to say the name of the object they have drawn and determines the accuracy of the pronunciation.

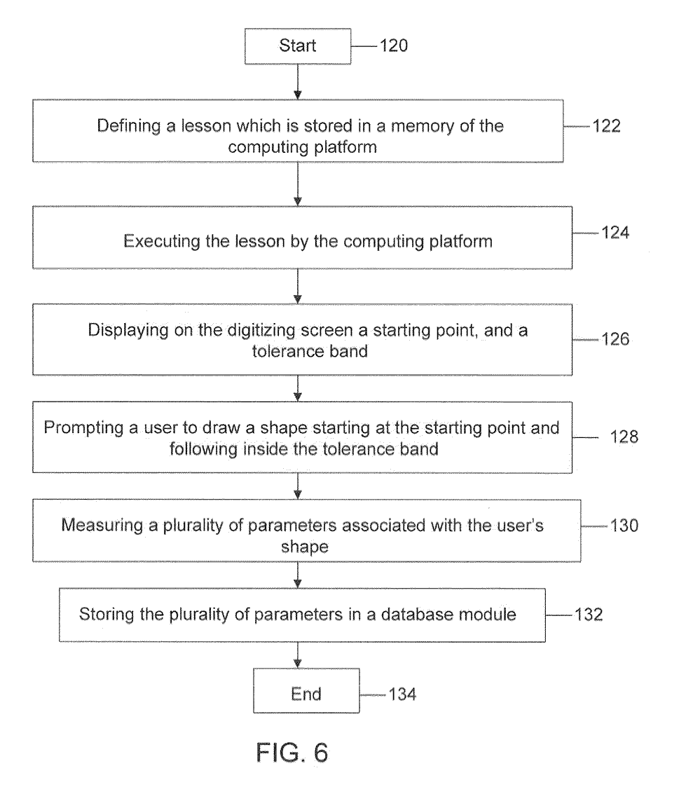

FIG. 6 is a flow chart of the steps used in a method of improving fine motor skills in accordance with one embodiment of the invention. The process starts, step 120, by defining a lesson which is stored in a memory of the computing platform at step 122. The lesson is executed by the computing platform at step 124. A tolerance band and a starting point are displayed on the digitizing screen at step 126. A user is prompted to draw a shape starting at the starting point and following inside the tolerance band at step 128. A plurality of parameters associated with the user's shape are measured at step 130. At step 132, the plurality of parameters are stored in a database module, which ends the process at step 134.

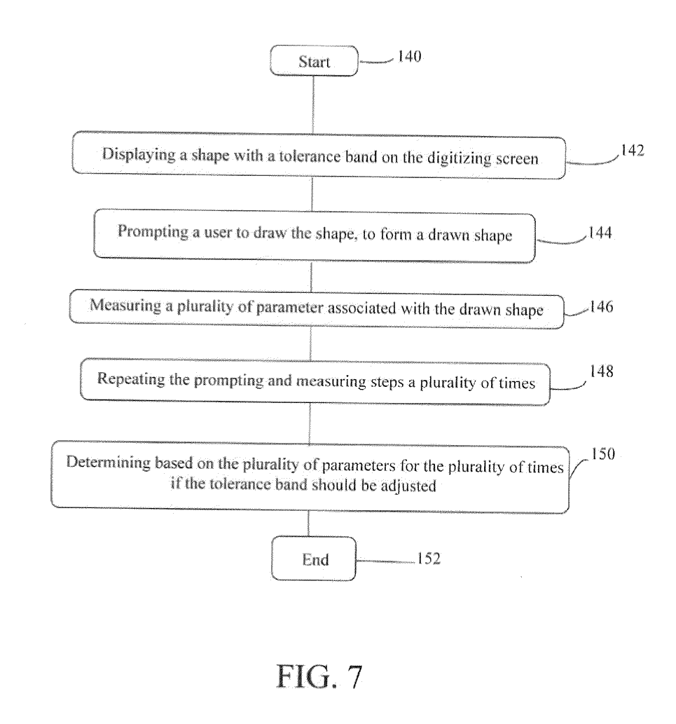

FIG. 7 is a flow chart of the steps used in a method of improving fine motor skills in accordance with one embodiment of the invention. The process starts, step 140, by displaying a shape with a tolerance band on the digitizing screen at step 142. The user is prompted to draw the shape at step 144. A plurality of parameters associated with the drawn shape are measured at step 146. The prompting and measuring steps are repeated a plurality of times at step 148. At step 150, it is determined based on the plurality of parameters for the plurality of times if the tolerance band should be adjusted, which ends the process at step 152.

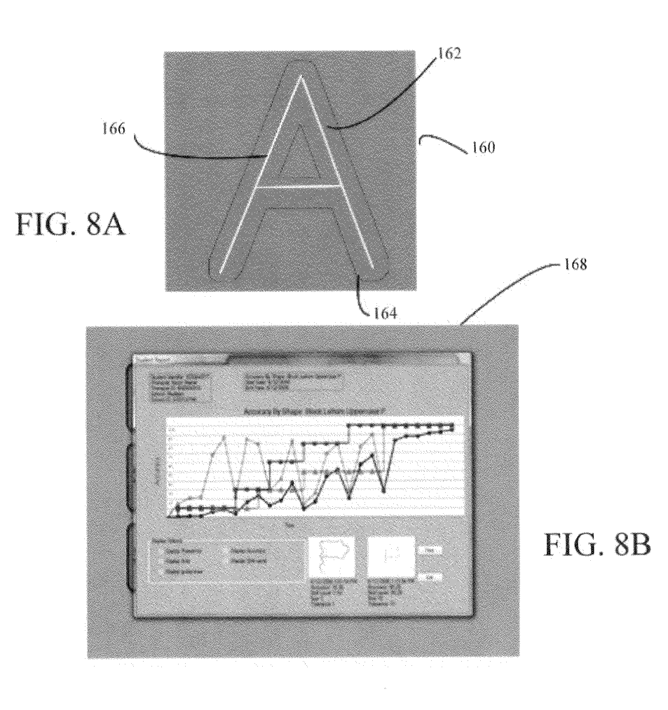

FIG. 8A is an example of an input screen 160 of a system for improving fine motor skills in accordance with one embodiment of the invention. The input screen shows the object “A” 162 to be drawn with visual tolerance bands 164 and a centerline 166 that defines the ideal path to be drawn. FIG. 8B is an example of an output screen 168 which shows the progress of the student over time.

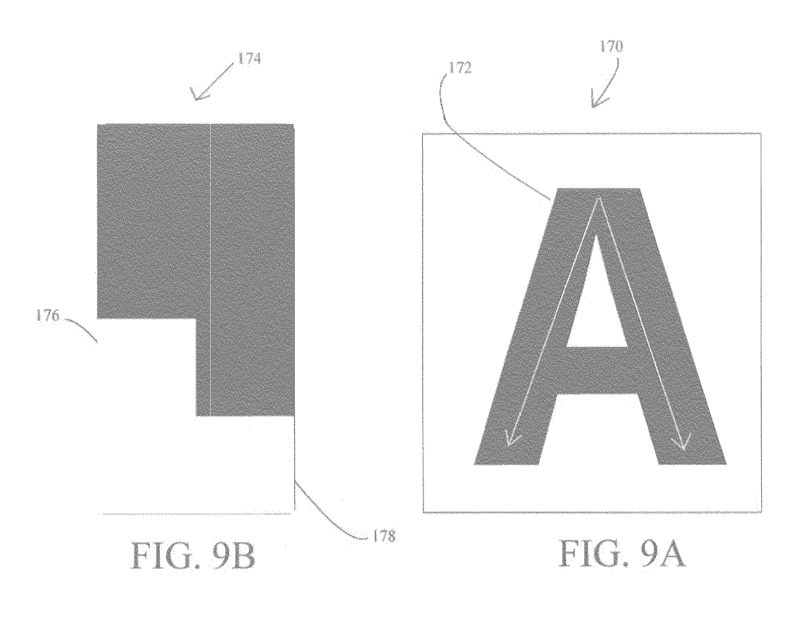

FIG. 9A is an example of an input screen 170 of a system for improving fine motor skills in accordance with one embodiment of the invention. The input screen 170 shows the present user's attempt 172 to draw the shape. FIG. 9B is an example of an output screen 174 of a system. The bar chart 176 shows the accuracy of the present attempt to draw the object and the bar chart 178 shows the average accuracy of the user at drawing the object. Note that the input and output screen are shown on the same physical screen and the bar chart is instantaneously updated as the user draws the shape.

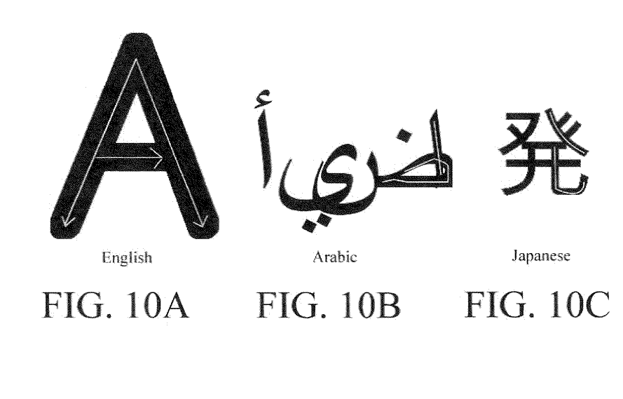

FIGS. 10A, 10B and 10C are examples of an input screens of a system for improving fine motor skills in accordance with one embodiment of the invention. FIG. 10A shows that the system can be used to teach the correct sequence strokes for English. FIG. 10B shows that the system can be used to teach the correct sequence strokes for Arabic. FIG. 10C shows that the system can be used to teach the correct sequence strokes for Japanese. The system can assist the user to learn how to write a variety of different languages.

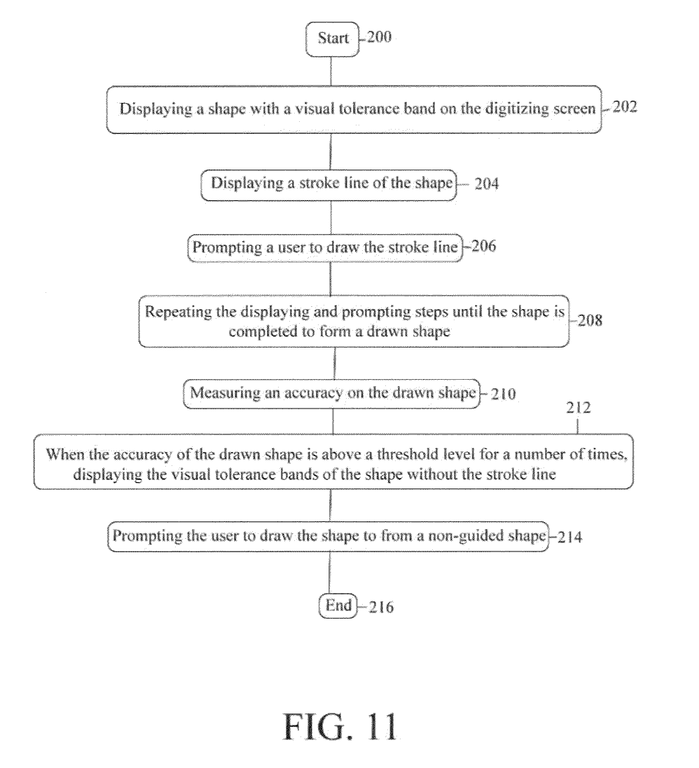

FIG. 11 is a method of teaching a user to write a foreign language in accordance with one embodiment of the invention. The process starts, step 200, by displaying a shape with a visual tolerance band on the digitizing screen at step 202. A stroke line of the shape is displayed at step 204. A user is prompted to draw the stroke line at step 206. The user then follows the next stroke line until the shape is completed at step 208. The accuracy of the drawn shape is measured at step 210. When the accuracy of the drawn shape is above a threshold for a predetermined number of times, the shape is displayed with the tolerance bands but without the stroke lines at step 212. At step 214, the user is prompted to draw the shape, which ends the process at step 216.

In one embodiment, the user continues to draw the shape without the stroke lines until they meet a certain level of accuracy for a predetermined number of times. The user is then prompted to draw the shape without the aid of the tolerance bands or the stroke lines. The user may be prompted to drawn the shape based on the computing platform telling the user to draw the shape or the user may be given the English (native language) equivalent of the shape or word.

Interactive Handwriting Training System and Method

Introduction

Problem:

The current method used around the world for teaching handwriting skills is basically the same today as it has been forever. Students and patients are given a writing instrument, something to write on and instructions that guide them through years of handwriting exercises including lines, shapes, numbers, upper and lower case letters and finally cursive handwriting. This is typically known as the paper and pencil method. Although very time consuming and difficult to quantify student and patient day to day progress, this is the universally accepted method of teaching handwriting. Those without a physical or mental learning disability typically respond well to this method, learn the accepted handwriting skills in several years time and move on to other higher education programs.

Those with physical and mental learning disabilities face additional challenges that greatly reduce the effectiveness of the traditional paper and pencil method and experience increased time and cost associated with learning to handwrite. Physical and mental challenges such as Autism, Attention Deficit Disorder (ADD), Cerebral Palsy, and Down Syndrome just to name a few present a whole different set of problems that the paper and pencil method does not effectively address. One of the main problems with the paper and pencil method is that the tests must be analyzed and scored manually. This allows for inaccuracies such as human error in judgment and subjective interpretations of the student's abilities that may result in inappropriate adjustments to the handwriting lessons, which has a negative impact on the educational process.

Patients recovering from stroke face a long rehabilitation process that many never complete because of the high degree of frustration associated with handwriting lessons using the paper and pencil method. The process of relearning to handwrite takes a very long time and many patients give up because they have no way of monitoring their progress. They think their handwriting skills will never improve and they become discouraged and give up.

Students attempting to learn to handwrite in different languages with different fonts and symbols such as those found in Far East and Middle East countries find the paper and pencil method very difficult and time consuming. Many students never learn to write in foreign languages because of the complexity of the different symbols, letters and shapes of foreign languages that the paper and pencil method does not effectively and efficiently teach.

A new method described herein is more effective at teaching handwriting skills to patients and students, especially those with physical and mental learning difficulties, by the combined use of an interactive handwriting training software program as described in the previous patent application and a electronic touch screen that provides audible, visual, and tactile stimulation during handwriting lessons. Precise handwriting data is captured and charted or displayed on the chart page in the software program. Handwriting lessons may be performed with instantaneous visual feedback based on accuracy. Also the program can be used for teaching the complex sequences of handwriting strokes such as those found in the handwritten languages of Far East and Middle East countries.

### DESCRIPTION OF THE INVENTION

A software program designed specifically to be used with an electronic touch screen or any kind of touch technology that has a touch screen and can capture precise data of the handwriting skills of the user. By writing software code that interacts with the user, stylus and a touch screen, four new methods for teaching handwriting skills are described herein.

PointScribe Overview

A software program that produces an improved method for teaching handwriting skills. A computer generated handwriting analysis chart guides teachers, parents, therapists and others needing to make informed decisions for improving and optimizing handwriting lessons.

The interactive handwriting training system consists of a software program designed to work with a tablet computer to perform precise analytical measurements of handwriting skills, as described in the previous patent. The new system converts the handwriting data into informative charts that provide a visual display of student and patient handwriting abilities. Teachers, parents and therapists use the analytical charts to guide their decisions at optimizing and improving (without human error in judgment or subjective interpretations) handwriting lessons in what is called “evidence based practice”. Lessons are created, modified and optimized based on the following computer generated handwriting data:
handwriting accuracy (deviation from center line)
number of failed attempts
time to complete a handwriting task
handwriting problems that may be associated with a particular color
handwriting problems that may be associated with different size fonts
handwriting problems that may be associated with different handwriting strokes, angles, shapes or shape size
handwriting problems that may be associated with different letter, number or shape sequences
handwriting problems that may be associated with different letter, number or shape combinations
handwriting abilities that may be affected by different types of adaptive stylus' or stylus grips
handwriting abilities that may be affected by different body position of the student or patient
handwriting abilities that may be affected by different positions, angles or location of the writing surface
handwriting abilities that may be affected by different types of audible motivations or distractions
other abilities or problems made obvious through the use of the interactive handwriting training system.

Precise handwriting data including type of shape, height of shape, width of shape, color of shape, date and time of each shape handwriting test, accuracy of handwriting ability (computerized measurement of deviation from centerline), length of time testing a particular shape, length of time testing all shapes, notes taken during each handwriting test, snapshots of each handwriting test, comparison of multiple snapshots at one time, and skill level calculated as [( height of shape+width of shape)×5]×Accuracy Value×0.01 is captured and charted or displayed on the chart page in the software program.

The chart page includes new graphics and precise representations of student's and patient's handwriting abilities and provides new opportunities to analyze, optimize and record handwriting lessons. The charts provide the teacher, parent or therapist with computer generated analytical data that guide them in determining the next steps to take in optimizing the handwriting lesson for patients and students.

Instantaneous Visual Feedback

A Software Program that Produces Instantaneous Handwriting Accuracy and Skill Level Visual Feedback/Information in Color Code or Numerical Value.

A software program designed specifically to interact with the user, stylus and electronic touch screen, will capture precise data of the handwriting skills of the user and display it instantly on the computer screen in a form that is easily interpreted by the user such as an active color coded bar chart, needle gauge or numerical value. The accuracy information will be displayed on the computer screen in close proximity to the handwriting task and in such a way that the user will be able to focus their attention on the handwriting task at hand and at the same time view their accuracy score through their peripheral vision.

The instantaneous handwriting accuracy information display will benefit the user because it allows the user to monitor their progress with a high degree of accuracy concurrent to their handwriting task. It removes the propensity for human error in judgment or subjective interpretations of handwriting skills typically associated with manual scoring methods. It indicates handwriting skills where the user has a high degree of accuracy and also where the user has difficulty and should continue more training. This motivates the user because it provides an easy, efficient, and effective way to challenge their previously generated scores, similar to the way challenge is found attractive in many popular video games.

This is very beneficial for patients recovering from stroke. Rehabilitating from stroke and other brain injuries may take a very long time and sometimes does not happen at all. Recovering the ability for written language may be extremely difficult, time consuming and frustrating. Patients typically become frustrated with relearning their handwriting skills because they can't discern from one day to the next or one month to the next if they are improving. The instantaneous handwriting accuracy and average accuracy information display of this invention will benefit patients by motivating them with an accurate method for scoring and tracking their progress.

Foreign Language Training Method

A Software Program that Produces a New Method for the Teaching of Sequential Writing Strokes in Any Type of Font or Language.

A software program designed specifically to interact with the user, stylus and electronic touch screen, will generate handwriting lessons in any language. The lessons are intended to teach proper techniques, stroke sequences, memorization, and pronunciation of any type of handwritten language. The user will select their current or native language. Next the user will select the language they desire to learn. The user will type a desired lesson (word, character, shape, number) in their current language and the software program will generate a handwriting lesson in the desired handwritten language.

In one variation, the method is a three-step process.

Step 1:

The lesson shape appears on the screen. The student is guided through every stroke of the lesson. As the user completes each stroke in the proper order and style consistent with the proper form and shape of the desired language, the next stroke will appear or become highlighted. This process will continue until the handwriting task has been successfully completed.

Step 2:

Following successful completion of Step 1, the lesson shape appears on the screen again. There are no visual prompts for guiding the student through the stroke sequence of the lesson. The student is required to recall the proper stroke sequence of the lesson.

Step 3:

Following successful completion of Step 2, the lesson continues but no lesson shape appears on the screen. The student makes the shape from memory as the computer records and evaluates stroke sequence and shape formation.

Auditory Association

Learning written communication skills is a complex process which involves memorizing how a shape looks, and how it feels to write the shape, also known as muscle memory. An additional component to learning to write a shape is memorizing how a shape sounds, or the auditory association with the written shape.

When a student is given a vocalized task to write the capital A letter, the student must first call on his memory of the auditory or spoken sound of the shape A, then he must be able to convert his memory and perception of the shape A into a voluntary and coordinated effort of fine motor movements with all of the necessary muscles to move the stylus to create the written shape A.

Previous details of the related patent application claimed new methods and systems for guiding, measuring and teaching, among other things, written communication skills.

A new software code has been written and integrated with the existing software code of the PointScribe system. The new code module is called Auditory Association. Auditory Association (AA) will provide a new method for teaching how each shape sounds, how to speak the shape, along with how it associates with the look and feel of writing the shape.

The new software produces, in any language, the vocalized version of any given shape, such as the letter A. The new code, integrated with the existing PointScribe software code, produces the vocalized A sound when the visual version of the shape A is produced on the electronic touch screen. The student then writes the shape A on the touch screen. The computer analyzes and scores the accuracy of the handwriting skill of the student for each particular shape, the shape A in this example. Upon completion of the written shape A, the software again produces the vocalized A sound, giving additional reinforcement for the sound, sight, and fine motor formation of the shape A. Additionally, the sound of the shape A could be reproduced any number of time during the handwriting lesson of shape A.

The AA improvement also provides the student with the opportunity to speak the sound of the shape A, or any other shape as that shape appears on the screen or after the student has written the shape. The new software code instructs the student to say the shape the student sees on the touch screen. The code will acknowledge properly vocalized shapes and progress on to the next shape in the lesson. It will also acknowledge improperly vocalized shapes and ask for a repeat until proper vocalization occurs. In another option dealing with failed or flawed vocalization, the software can give a lower score and move on to the next shape as selected by the educator.

The vocalized sounds can be in any language and in any form such as the sound of a male, female, child, adult, or synthesized to meet the needs of the student.

Auto Challenge

Teaching written communication skills has many difficult challenges, including applying the appropriate challenge or size for every written shape to each individual student, and in any language. One of the challenges of written communication skills occurs when the size of the shape being written is reduced from large novice sized shapes to smaller and more refined shapes as is consistent with typical adult handwriting skills.

When students first learn to handwrite, they are given larger sized handwriting tasks, because it requires less refined fine motor skills to write larger shapes than it does to write smaller shapes. As students improve their fine motor skills, they generally reduce the size of their print. Properly matching the size, or challenge of each shape with each individual student as they are learning to handwrite has been very difficult to achieve with the paper and pencil method.

New code has been developed that works with the existing PointScribe software that provides a method for computerized analysis and adjustment of the challenge of each shape for each individual student. The existing code provides a score based on how accurately each shape has been written by each student. The new code uses this information, combines it with parameters that are predetermined by the teacher, and through simple computations, sets the size or challenge of the shape on the touch screen to match the handwriting skill level of the student.
Teacher selects the criteria upon which the lessons will automatically increase in challenge to match the student's ability.
PointScribe analyzes current accuracy score in database for each shape executed by a student. If accuracy score is greater than predetermined value set by teacher and the student has met or exceeded the predetermined number of successful completions set by teacher, PointScribe will increment the shape and or tolerance by a value of one or more.
For example, if the teacher selects an accuracy level of 75 with 4 as the desired number of completions, when the student has completed the shape 4 consecutive times with an accuracy score of 75 or better, size and/or tolerance will increment by a level of one or more (as predetermined by the teacher).

As the student begins to practice his handwriting skills, the accuracy score improves and goes higher. When the score reaches a predetermined and preset value, the size or challenge of the shape is adjusted to a slightly smaller size by the software to match the improved handwriting skills of the student. The student continues to practice handwriting at the smaller and more challenging shape size. Soon the students' accuracy score improves and reaches the predetermined and preset value again, and the size or challenge of the shape is adjusted again by the software to match the improved handwriting skills of the student. This method of practice, improve, and adjust, continues on until the student has greatly improved their handwriting skills from very large novice shapes to much smaller and more refined handwritten shapes.

In this new code, a new method has been developed that provides automated adjustments to handwriting lessons. This new method consistently ensures that each student is being challenged appropriately for each shape. The new code efficiently teaches students to write smaller and more refined shapes in a reduced period of time when compared to the paper and pencil method.

Note that the auto challenge technology can be applied to the auditory association also, so that a student's auditory skills are constantly challenged

Conclusion

Prior to this invention, handwriting abilities were subjectively scored by observations and estimations of the accuracy and skill level of the results of handwriting tests performed on paper and pencil which produced biased, inaccurate and non-quantifiable results. The invention described herein provides a non-biased, accurate, quantifiable and standardized method for improving handwriting skills through “evidence based practice” training techniques.

The invention solves the problems described in the first section in the follow ways:
It is more effective at teaching handwriting skills to children because it promotes eye to hand convergence, it guides the student through every stroke sequence of the lesson, and it generates charts and data that guide the teacher and therapist in creating optimized handwriting lessons based on the needs of each individual student and patient.
It saves money and time because less time and resources are required to teach the student and patient to handwrite.
It will succeed at teaching more students and patients to handwrite than the conventional paper and pencil method because the computerized analysis of the handwriting skills will provide critical information that the paper and pencil method is not capable of producing.
It is more effective and efficient at regaining handwriting skills lost in stroke or other brain injury patients because it reduces frustration and provides motivation in the process of relearning to handwrite by providing an instantaneous feedback on their handwriting abilities.
The invention reduces the time to learn handwriting skills containing different and complex stroke sequences by computer automating the lessons and computer generating the proper techniques and stroke sequences of any type of handwritten language.
The invention allows the student to practice their auditory skills while improving their handwriting skill. This provides an additional training feature and multiple forms of feedback for the student.
The invention provides an automatic adjustment feature for the handwriting so the student is constantly challenged at the appropriate level.

Thus there has been defined a system and method that is interactive, that is more effective at capturing the student's attention and decreases the time it takes them to learn to write. This decreases the cost of teaching these students to write. Using this system the child is provided positive audio feedback and visual feedback of the progress they are making. This feedback captures the child's attention and increases the number of exercises they are willing to perform during a lesson with a therapist. The system also includes an auto challenge module that automatically increases the lesson difficulty as the child progress. The system tracks a child's progress and displays graphics of their progress. In one embodiment, the system announces the sound of the shape the user is attempting to draw. The system may also request that the user pronounce the name of the shape they are drawing and determine a correctness of their pronunciation.

Standard writing lessons fail to capture the attention of a child with VAD (visual attention disorder) or other attention deficient disorders. As a result, standard writing lessons that do riot provide immediate positive feedback will not succeed in teaching these children fine motor skills.

The methods described herein can be implemented as computer-readable In instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for improving fine motor skills comprising:
a computing platform;
a digitizing screen in communication with the computing platform;
a speaker receiving an audio information from the computing platform;
a memory associated with the computing platform containing,
a writing module that defines a plurality of lessons for a student, each of the plurality of lessons including a visual tolerance band,
an auditory association module that is called by at least one of the plurality of lessons and transmits a signal to the speaker to output a sound of an object the student is to draw in the at least one lesson.

2. The system of claim 1, further including a student analysis and database module that receives input from the digitizing screen and determines a plurality of parameters associated a students performance and graphically displays a set of the plurality of parameters on the digitizing screen.

3. The system of claim 2, further including an auto challenge module that receives a set of the plurality of parameters and determines if a difficulty level for a certain exercise should be adjusted.

4. The system of claim 1, further including a stylus that has no electronics.

5. The system of claim 1, wherein the plurality of lessons include a lesson in non-Latin symbols.

6. The system of claim 1, further including a server in communication with the computing platform, the server containing a second plurality of lessons.

7. The system of claim 2, wherein the plurality of parameters include a difficulty level, and a number of failed attempts.

8. A method of improving fine motor skills using a computing platform having a digitizing screen, comprising the steps of:
defining a lesson which is stored in a memory of the computing platform;
executing the lesson by the computing platform;
displaying on the digitizing screen a starting point, and a visual tolerance band;
prompting a user to draw a shape starting at the starting point and following inside the visual tolerance band;
measuring a plurality of parameters associated with the user's shape;
storing the plurality of parameters in a database module; and
determining based on the plurality of parameters for the plurality of lessons, if the tolerance band should be adjusted.

9. The method of claim 8, further comprising the steps of:
storing the plurality of parameters for the user over a plurality of lessons;
graphically displaying at least one of the plurality of parameter for the plurality of lessons for the user.

10. The method of claim 9, wherein the step of graphically displaying include displaying the at least one of the plurality of parameters versus time.

11. The method of claim 8, wherein the step of displaying on the digitizing screen the starting point includes the step of playing a sound associated with a shape to be drawn.

12. The method of claim 8, further including the step of:
requesting a user to vocalize a sound associated with the shape the user has drawn;
comparing the sound with a reference sound for the shape;
determining a closeness between the sound and the reference sound.

13. The method of claim 8, further including the step of when the tolerance band should be adjusted, adjusting the tolerance band.

14. The method of claim 8, further including the step of determining based on the plurality of parameters for the plurality of lessons, if a size of the shape should be adjusted.

15. The method of claim 14, further including the step of when the size of the shape should be adjusted, adjusting the size of the shape.

16. A method of improving fine motor skills using a computing platform having a digitizing screen, comprising the steps of:
displaying a shape with a visual tolerance band on the digitizing screen;
displaying a stroke line of the shape;
prompting a user to draw the stroke line;
repeating the displaying and prompting steps until the shape is completed to form a drawn shape;
measuring an accuracy the drawn shape;
when the accuracy of the drawn shape is above a threshold level for a number of times, displaying the visual tolerance bands of the shape without the stroke line; and
prompting the user to draw the shape to from a non-guided shape.

17. The method of claim 16, further including the steps of:
measuring an accuracy of the non-guided shape;
when the accuracy of the non-guided shape is above a threshold level for a number of times, requesting the user to draw the shape on without any guidance to form a free hand shape.

18. The method of claim 17, further including the step of measuring an accuracy of the free hand shape.

19. The method of claim 16, further including the step of when the user does not draw a first stroke correctly, providing a negative feedback to the user.

20. The method of claim 19, wherein the negative feedback includes the digitizing screen not displaying the line the user has drawn.
